(19) United States
(12) Patent Application Publication
(10) Pub. No.: US 2022/0120944 A1
(43) Pub. Date: Apr. 21, 2022

(54) FLUIDIC LENS WITH VARIABLE FOCAL LENGTH

(71) Applicant: Edenlux Corporation, Gyeongsangnam-do (KR)

(72) Inventors: Dong Hee LEE, Gyeonggi-do (KR); Sung Yong PARK, Gyeonggi-do (KR)

(73) Assignee: Edenlux Corporation, Gyeongsangnam-do (KR)

(21) Appl. No.: 17/289,888

(22) PCT Filed: Oct. 31, 2019
(86) PCT No.: PCT/KR2019/014615

§ 371 Date: Nov. 24, 2021

(30) Foreign Application Priority Data
Oct. 31, 2018 (KR) 10-2018-0132287

(51) Int. Cl. G02B 3/14; G02B 26/00

(52) U.S. Cl. CPC G02B 3/14; G02B 26/004

(57) ABSTRACT

A fluidic lens according to the present invention comprises: a first membrane and a second membrane which face each other; a first means for forming a magnetic field in the first membrane and a second means which exhibits a magnetic force with respect to an external magnetic field formed in the second membrane; a fluid chamber which forms a space between the first membrane and the second membrane and is filled with fluid; and a supplementary chamber connected to the fluid chamber, wherein the second means generates a magnetic force via the magnetic field generated by the first means, thereby causing attraction and repulsion between the first membrane and the second membrane to adjust the focal length of the lens.

### TECHNICAL FIELD

The disclosure relates to a fluidic lens with a variable focal length. More specifically, the disclosure relates to a fluidic lens which uses a magnetic field to change a focal length.

### BACKGROUND ART

Unlike a conventional lens made from a transparent material such as glass, the surface of which is processed into a spherical surface, to focus or disperse light coming from an object to thereby form an optical image, a lens of which the focal length or focal position is changeable is called a varifocal lens.

As an example of such a varifocal lens, a paper titled “Tunable-focus lens for adaptive eyeglasses”—Optical Express Vol. 25 1221-1233 (2017) has disclosed a lens in which fluid is filled and sealed between upper and lower elastic membranes and a flat piston connected to the lower elastic membrane is used to change a focal length.

In more detail, the upper elastic membrane becomes concave to form a lens having a negative refractive power when the piston connected to the lower elastic membrane is pulled, but becomes convex to form a lens having a positive refractive power when the piston is pushed.

Further, there has been a conventional varifocal lens in which the upper and lower elastic membranes are not completely sealed and fluid is injected or withdrawn between the upper and lower elastic membranes to form a convex or concave lens.

However, in a case where such conventional varifocal lenses have a large diameter, it is difficult to make the surface of the elastic membrane be shaped close to a spherical surface because the surface of the membrane in a circumferential direction is not controllable in portions at a predetermined distance away from the center of the membrane in a radial direction, or in particular it is further difficult to make the surface of the membrane have an aspherical shape. When the surface of the membrane has an aspherical shape, it is advantageous to manufacture a fluidic lens with a variable focal length, which is excellent in forming and focusing an image, because the aberration of the lens is under control. In other words, the conventional varifocal lenses do not have such an advantage.

### DISCLOSURE

### Technical Problem

An aspect of the disclosure is to provide a fluidic lens which uses fluid to change a focal length.

Another aspect of the disclosure is to provide a fluidic lens, in which at least one first means forming a variable magnetic field is provided in one of a first membrane and a second membrane forming two surfaces of the fluidic lens, and at least one second means exhibiting a magnetic force based on a surrounding magnetic field is provided in the other one, so that a space between the first membrane and the second membrane can become concave or convex as the magnetic field caused by the first means pulls or pushes the second means, thereby making the first membrane, the second membrane and fluid filled in the space between the two membranes to serve as a lens having refractive power.

Still another aspect of the disclosure is to provide a fluidic lens having ability to change a focal length by adjusting the strength of the magnetic field and force acting between a first means, which is provided in one of the first membrane and the second membrane of the fluidic lens and forms a variable magnetic field, and a second means, which is provided in the other one and exhibits a magnetic force based on a surrounding magnetic field.

Yest another aspect of the disclosure is to provide a fluidic lens with a variable focal length, excellent in ability to form and focus an image, in which at least one first means for generating a variable magnetic field in the first membrane and the second membrane of the fluidic lens and at least one second means for exhibiting a magnetic force based on the surrounding magnetic field are properly placed, so that the strength of the magnetic field and force acting between the two membranes can be continuously varied from the center of the space between the first membrane and the second membrane toward the periphery thereof, in other words, the shape of the membrane, i.e. the surface of the membrane in a circumferential direction can be controllable in portions at a predetermined distance away from the center of the membrane in a radial direction even though the fluidic lens increases in diameter, thereby making the surface of the membrane be shaped very close to a spherical surface, or in particular making the surface of the membrane have an aspherical shape for better aberration control of the lens.

### Technical Solution

The foregoing and other aspects of the disclosure may be achieved by a fluidic lens with a variable focal length.

A fluidic lens with a variable focal length according to the disclosure includes: a first membrane comprising one or more first means for forming a variable magnetic field; a second membrane comprising one or more second means for exhibiting a magnetic force based on a surrounding magnetic field; a fluid chamber forming a space between the first membrane and the second membrane while holding an edge of the first membrane and an edge of the second membrane at positions opposite to each other, and comprising fluid filled in the space; and a supplementary chamber connected to the fluid chamber, supplying the fluid to the space when the space is increased in volume and receiving the fluid from the space when the space is decreased in volume.

The first membrane may further include the second means, or the second membrane may further include the first means. Further, both the first membrane and the second membrane may include the first means and the second means.

At least one of the first membrane and the second membrane may include an elastic membrane having flexibility.

The first means or the second means may be a conducting wire.

The second means may contain a ferromagnetic substance or a magnetized ferromagnetic substance.

The ferromagnetic substance may include one or more among dispersed ferromagnetic-substance granules, a geometrical ferromagnetic-substance pattern, and a thin ferromagnetic-substance film.

The first means and the second means may include a material having optical transmittance in a visible region.

The supplementary chamber may include a pressure means for providing pressure to the fluid

The supplementary chamber may include a movable piece forming a boundary between a space filled with fluid and the rest of the space, and the pressure means includes a tension spring including one end connected to the movable piece and positioned inside the space filled with the fluid, or a compression spring including one end connected to the movable piece and positioned inside the rest of the space.

The conducting wire may include a circular conducting-wire opened at one side or a spiral conducting-wire, and the conducting wire may include a first end and a second end to which two parallel electric wires are connected, respectively

The conducting wire may include a plurality of circular conducting-wires opened at one side, and the plurality of circular conducting-wires may be concentrically arranged and different in diameter from each other. Further, each of the circular conducting-wires may include a first end and a second end to which two parallel electric wires are connected, respectively, and the electric wires connected to the circular conducting-wires may be arranged at intervals of a predetermined angle.

Further, the first membrane and/or the second membrane of the fluidic lens according to the disclosure may include an elastic material having flexibility.

Further, one of the first membrane and the second membrane of the fluidic lens according to the disclosure may include an elastic material having flexibility, and the other one may include a nonelastic material having no flexibility.

### Advantageous Effects

The disclosure has an effect on providing a fluidic lens, in which at least one first means forming a variable magnetic field is provided in one of a first membrane and a second membrane forming two surfaces of the fluidic lens, and at least one second means exhibiting a magnetic force based on a surrounding magnetic field is provided in the other one, so that a space between the first membrane and the second membrane can become concave or convex as the magnetic field caused by the first means pulls or pushes the second means, thereby making the first membrane, the second membrane and fluid filled in the space between the two membranes to serve as a lens having refractive power.

The disclosure has an effect on providing a fluidic lens, in which a focal length is changeable by controlling the strength of a magnetic field and a magnetic force exhibited between the first means and the second means.

The disclosure has an effect on providing a fluidic lens, in which the first means and the second means are properly placed, so that the strength of the magnetic field and force acting between the two membranes can be continuously varied from the center of the space between the first membrane and the second membrane toward the periphery thereof, thereby keeping the shape of the membrane to have a spherical surface or an aspherical surface for better aberration control even though the fluidic lens increases in diameter.

### DESCRIPTION OF DRAWINGS

FIG. 1 is a perspective view of a fluidic lens according to a first embodiment of the disclosure.

FIG. 2 is a cross-sectional view of the fluidic lens according to the first embodiment of the disclosure.

FIG. 3 shows an illustrative structure of a first membrane of the fluidic lens according to the first embodiment of the disclosure.

FIG. 4 shows an illustrative structure of a second membrane of the fluidic lens according to the first embodiment of the disclosure.

FIG. 5 shows operations of the fluidic lens according to the first embodiment of the disclosure, when electric currents in conducting wires of the first and second membranes flow in the same direction.

FIG. 6 shows operations of the fluidic lens according to the first embodiment of the disclosure, when electric currents in the conducting wires of the first and second membranes flow in opposite directions.

FIGS. 7 and 8 are cross-sectional views of the fluidic lens with a pressure means according to the first embodiment of the disclosure.

FIG. 9 shows an illustrative membrane including a plurality of circular conducting-wires.

FIG. 10 shows an illustrative membrane including a spiral conducting-wire.

FIG. 11 shows an illustrative membrane in which a plurality of circular conducting-wires forms a spiral conducting-wire.

FIG. 12 shows operations of a fluidic lens according to a second embodiment of the disclosure, when an electric current in a conducting wire of a second membrane flows in a first direction.

FIG. 13 shows operations of a fluidic lens according to the second embodiment of the disclosure, when the electric current in the conducting wire of the second membrane flows in a second direction (opposite to the first direction).

FIG. 14 shows operations of the fluidic lens according to the second embodiment of the disclosure, in which the first membrane is a nonelastic material and the second membrane is an elastic material.

FIG. 15 shows an illustrative membrane in which granules or nanogranules of a ferromagnetic substance is dispersed and distributed.

FIG. 16 shows an illustrative membrane in which a ferromagnetic substance is distributed in a concentric pattern

FIG. 17 shows an illustrative membrane in which a ferromagnetic substance is distributed in a lattice pattern.

FIG. 18 shows operations of a fluidic lens according to a third embodiment of the disclosure, when an electric current in a conducting wire of a second membrane flows in a first direction.

FIG. 19 shows operations of a fluidic lens according to the second embodiment of the disclosure, when the electric current in the conducting wire of the second membrane flows in a second direction (opposite to the first direction).

FIG. 20 shows operations of the fluidic lens according to the third embodiment of the disclosure, in which a first membrane is a nonelastic material and the second membrane is an elastic material.

FIG. 21 is a cross-sectional view showing an embodiment, in which a distance between an edge of a first membrane and an edge of a second membrane is different according to regions.

### MODE FOR CARRYING OUT DISCLOSURE

Below, a fluidic lens with a variable focal length according to the disclosure will be described in detail with reference to the accompanying drawings.

In the following, descriptions will be made only to understood a fluidic lens with a variable focal length according to the embodiments of the disclosure, and the other descriptions may be omitted to avoid clouding the gist of the disclosure.

Further, terms or words used in the specification set forth herein and the appended claims should be not interpreted as a typically or lexically limited meaning but interpreted as having a meaning and concept, which are consistent with the technical idea of the disclosure, to most suitably represent the disclosure.

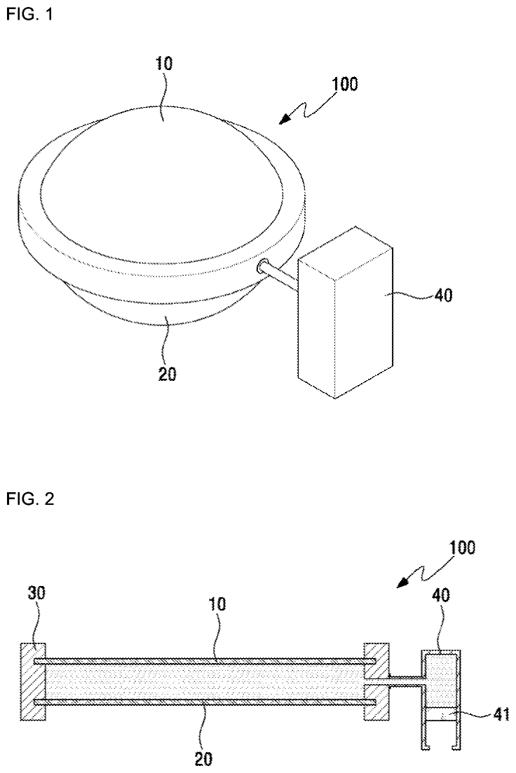

FIGS. 1 and 2 respectively show a perspective view and a cross-sectional view of a fluidic lens 100 according to a first embodiment of the disclosure.

As shown in FIGS. 1 and 2, the fluidic lens 100 according to the first embodiment of the disclosure includes a first membrane 10, a second membrane 20, a fluid chamber 30, and a supplementary chamber 40.

The first membrane 10 and the second membrane 20 refer to thin films capable of preventing fluid from leaking out of the fluid chamber 30, and at least one of the first membrane 10 and the second membrane 20 may be a flexible elastic membrane that can be deformed by external force.

The edges of the first and second membranes are spaced apart at a certain distance from each other and face each other. Further, to maintain the distance, the edges of the first and second membranes may be fastened to the fluid chamber 30. In other words, as shown in FIG. 2, the first membrane 10 and the second membrane 20 face each other leaving a predetermined distance therebetween, and the edges thereof are fixed to the fluid chamber so as to maintain the distance between the edge of the first membrane and the edge of the second membrane.

The distance between the edge of the first membrane and the edge and the second membrane is to maintain the minimum distance not to the first membrane and the second membrane be in contact with each other even though attraction occurs between the first membrane and the second membrane due to a magnetic field and a magnetic force.

Next, the fluid chamber 30 forms a space between the first membrane and the second membrane. The space between the first membrane and the second membrane is filled with fluid, and the fluid may include fluid having a certain refractive index.

The space between the first membrane and the second membrane is varied in volume depending on attraction or repulsion between the first membrane and the second membrane due to the magnetic field and the magnetic force (to be described later).

Thus, the fluidic lens 100 according to the first embodiment of the disclosure includes a supplementary chamber 40 at one side of the fluid chamber 30 as shown in FIG. 2, and allows the fluid to flow between the fluid chamber and the supplementary chamber, thereby changing the volume of the space between the first membrane and the second membrane.

In more detail, the inside of the fluid chamber is fully filled with the fluid, and the supplementary chamber 40 is divided by a movable piece 41 as shown in FIG. 2 into a space filled with the fluid and an opened space filled with no fluid. In this case, the space inside the fluid chamber communicates with the space inside the supplementary chamber filled with the fluid, and the movable piece moves to move the fluid between the fluid chamber and the supplementary chamber as internal pressure is changed, thereby changing the volume of the space between the first membrane and the second membrane.

Below, elements for adjusting the focal length of the fluidic lens according to the first embodiment of the disclosure and corresponding change in position of the elements will be described in more detail.

The fluidic lens 100 according to the disclosure uses the magnetic field and the magnetic force to adjust the focal length of the lens.

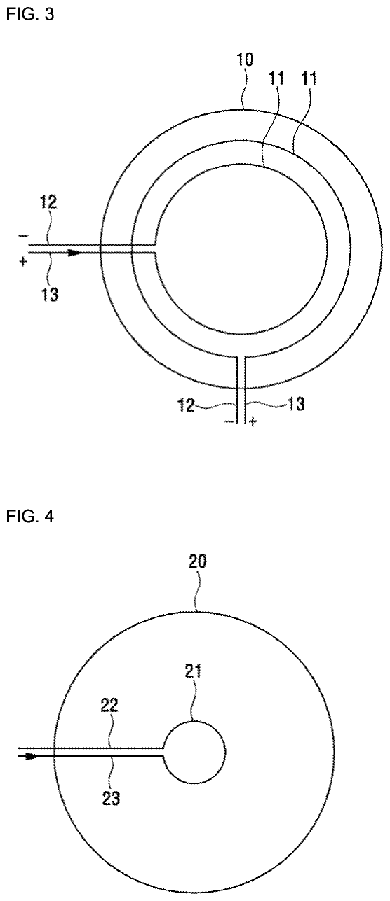

To this end, as shown in FIG. 3, a conducting wire 11 is provided inside the first membrane 10 as a first means for forming a variable magnetic field, and the conducting wire 11 includes a first end and a second end respectively connected to electric wires 12 and 13 for supplying an electric current to the conducting wire.

Further, as shown in FIG. 4, a conducting wire 21 is also provided inside the second membrane 20 as a second means for exhibiting the attraction or repulsion based on the surrounding magnetic field, and the conducting wire 21 includes a first end and a second end respectively connected to electric wires 22 and 23 for supplying an electric current to the conducting wire.

The first means and the second means may be made of a material having optical transmittance in a visible region because the first means and the second means are included in the first membrane and the second membrane forming the fluidic lens.

FIG. 3 shows two circular conducting-wires as the first means, and FIG. 4 shows one circular conducting-wire as the second means. However, the number, diameter, etc. of such circular conducting-wire may be properly varied depending on simulation results for a magnetic force and distribution of a necessary magnetic field.

When the foregoing first and second membranes are disposed to face each other and the electric current is supplied to flow in the conducting wires of the first means and the second means in the same direction, attraction occurs between the first membrane and the second membrane, thereby causing the fluidic lens 100 according to the first embodiment of the disclosure to become a lens having negative refractive power.

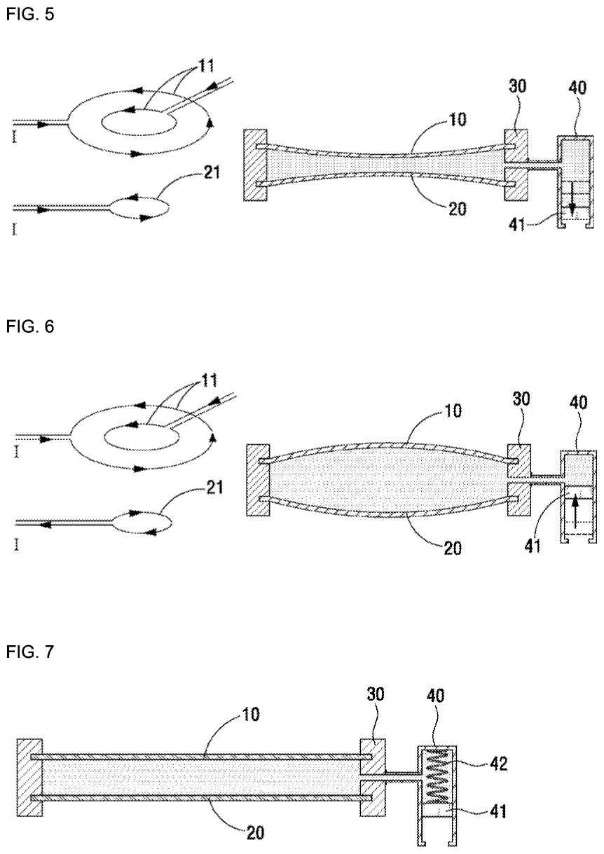

In more detail, as shown in FIG. 5, when the electric current flows counterclockwise in the conducting wire 11 and the conducting wire 21, the center of the bottom side of the first membrane serves as the S pole and the center of the top side of the second membrane serves as the N pole, thereby causing the attraction therebetween.

As above, the attraction caused by the magnetic field increases the pressure in the space between the first membrane and the second membrane, and the increased pressure makes the movable piece 41 move to the opened space filled with no fluid and the fluid move from the fluid chamber to the supplementary chamber.

With the foregoing movement of the fluid, the first membrane and the second membrane have a concave shape in an inward direction of the fluid chamber, and the fluidic lens 100 according to an embodiment of the disclosure becomes the lens having the negative refractive power.

Next, when the first membrane and the second membrane are disposed to face each other and the electric current is supplied to flow in the conducting wires of the first means and the second means in the opposite directions, repulsion occurs between the first membrane and the second membrane, thereby causing the fluidic lens 100 according to the first embodiment of the disclosure to become a lens having positive refractive power.

In more detail, as shown in FIG. 6, when the electric current flows counterclockwise in the conducting wire 11 of the first membrane but the electric current flows clockwise in the conducting wire 21 of the second membrane, the center of the bottom side of the first membrane serves as the S pole and the center of the top side of the second membrane also serves as the S pole, thereby causing the repulsion therebetween.

As above, the repulsion caused by the magnetic field makes the first membrane and the lower membrane repel each other and thus decreases the pressure in the space between the first membrane and the second membrane. By the decreased pressure, the fluid moves from the supplementary chamber into the fluid chamber, and the movable piece 41 moves toward the space filled with the fluid.

With the foregoing movement of the fluid, the first membrane and the second membrane have a convex shape in an outward direction of the fluid chamber, and the fluidic lens 100 according to the first embodiment of the disclosure becomes the lens having the positive refractive power.

As described hitherto, the fluidic lens 100 according to the first embodiment of the disclosure is transformed into the convex lens having the positive refractive power or the concave lens having the negative refractive power by controlling the directions of the electric currents flowing in the conducting wires of the first membrane 10 and the second membrane 20. Further, the amount of electric current flowing in the conducting wire is adjusted by controlling the strength of the magnetic force and the magnetic field, thereby adjusting the volume of the space between the first membrane and the second membrane. This is the same as adjustment of a convex or concave degree of the first membrane and the second membrane, in other words, adjustment of the radii (r₁, r₂) of curvature the first and second sides of the fluidic lens have. Therefore, it will be understood that the focal length is changed by adjusting the radii r₁ and r₂ of curvature, as shown in the following expression 1. In other words, the radii (r₁, r₂) of curvature the first and second sides of the fluidic lens have are changed as the amount of electric current flowing in the conducting wires of the first membrane and the second membrane is adjusted to control the strength of the magnetic force and the magnetic field, thereby controlling the fluidic lens to have a desired focal length.

$$\frac{1}{f} = \frac{( n - 1 )}{{r}_{1}} + \frac{( 1 - n )}{{r}_{2}} - \frac{t}{n} ⨯ \frac{( n - 1 )}{{r}_{2}} \times \frac{( 1 - n )}{{r}_{2}} \qquad ( Expression 1 )$$

f; focal length

n; refractive index of fluid

r₁: radius of curvature of first side

r₂; radius of curvature of second side

t; central thickness of lens

(where, the above expression is established on the assumption that the first membrane and the second membrane are very thin. Further, the sign of each term in the above formula follows the general rules of geometric optics.)

FIGS. 5 and 6 show a case where the first membrane and the second membrane of the fluidic lens according to the first embodiment are made of an elastic material having flexibility, in which FIG. 5 illustrates a bi-concave lens and FIG. 6 illustrates a bi-convex lens.

When one of the two membranes is made of a non-elastic material having no flexibility, a plano-concave, plano-convex, concave-plano or convex-plano fluidic lens may be formed.

However, when the fluidic lens 100 according to the first embodiment of the disclosure is vertically stood, the shape of the lens may be deformed as the fluid between the first membrane and the second membrane is pulled down by gravity.

Therefore, a pressure means may be additionally provided to give pressure to the fluid not to be pulled down in the direction of gravity even though the fluidic lens 100 according to the first embodiment of the disclosure vertically stands.

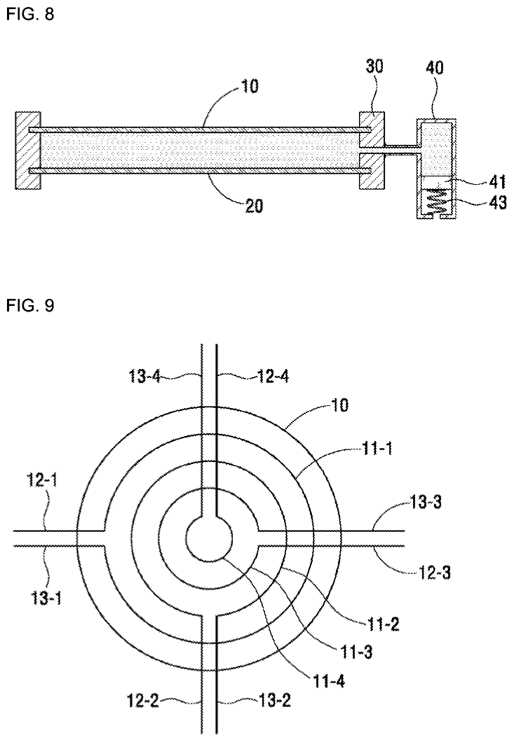

For example, as shown in FIG. 7, the pressure means may include a tension spring 42 having one end connected to the movable piece 41 and positioned inside the space of the supplementary chamber filled with the fluid. Further, as shown in FIG. 8, the pressure means may include a compression spring 43 having one end connected to the movable piece 41 and positioned inside the space of the supplementary chamber filled with no fluid.

Any of the tension spring 42 and the compression spring 43 provides predetermined pressure to the fluid filled in the fluid chamber and the supplementary chamber, thereby preventing the fluid from being pulled down in the direction of gravity even though the fluidic lens 100 stands vertically.

Referring back to FIGS. 3 and 4, the conducting wires provided as the first means and the second means involved in the first membrane 10 and the second membrane 20 may include circular conducting-wires opened at one side. As described above, the electric wires 12, 13; 22, 23 for supplying the electric current are connected to opened end portions of the circular conducting-wires, in which two parallel electric wires are arranged as close as possible to each other so that the magnetic fields of the two electric wires can be canceled to thereby have a minimum effect on the magnetic field created in the surrounding conducting wire.

The conducting wire and the electric wire may include a transparent conducting wire or an opaque conducting wire of 100 μmor below so as not to be visible. Therefore, the conducting wire and the electric wire may for example contain one of transparent conducting oxide (TCO), silver nanowire, carbon nanotube (CNT), graphene, conducting polymer, indium tin oxide (ITO), zinc oxide (ZnO), indium zinc oxide (IZO), and indium gallium zinc oxide (IGZO).

Further, the conducting wires provided as the first means and the second means involved in the first membrane 10 and the second membrane 20 may include a plurality of circular conducting-wires 11-1, 11-2, 11-3 and 11-4 opened at one side. In this case, the plurality of circular conducting-wires may be different in diameter from each other and concentrically arranged as shown in FIG. 9.

In this case, the electric wires 12-1, 13-1; 12-2, 13-2; 12-3, 13-3; 12-4, 13-4 respectively connected to the circular conducting-wires may be arranged at intervals of a predetermined angle, and transparent non-conductive oxide or the like insulator may be inserted between the conducting wire and the electric wire to prevent the electric wire connected to an inward conducting wire from being electrically connected to an outward conducting wire.

When such a plurality of circular conducting-wires are used to form the first means and the second means of the first membrane 10 and the second membrane 20, the amount of electric current can be suitably distributed in each circular conducting-wire to make the membranes have a spherical surface or have an aspherical surface for better aberration control.

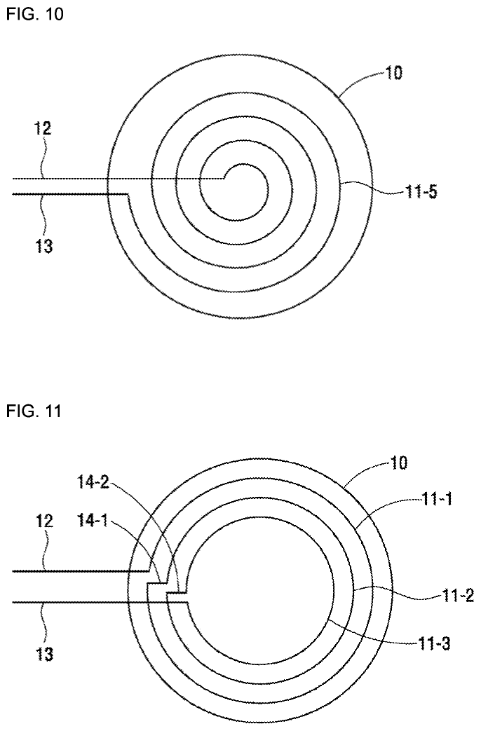

Further, the conducting wires provided as the first means and the second means of the first membrane 10 and the second membrane 20 may include a spiral conducting-wire 11-5 as shown in FIG. 10, or may form a spiral conducting-wire in such a manner that a plurality of circular conducting-wires opened at one side are connected by connection lines 14-1 and 14-2 as shown in FIG. 11.

Further, as shown in FIG. 9, the plurality of conducting wires for the first membrane 10 and the second membrane 20 may be distributed at positions determined based on simulation results for magnetic-field distribution requiring a plurality of circular conducting-wires concentrically surrounding the center of the membrane. With this, the membrane may be shaped close to a spherical shape or may have an aspherical shape for better aberration control.

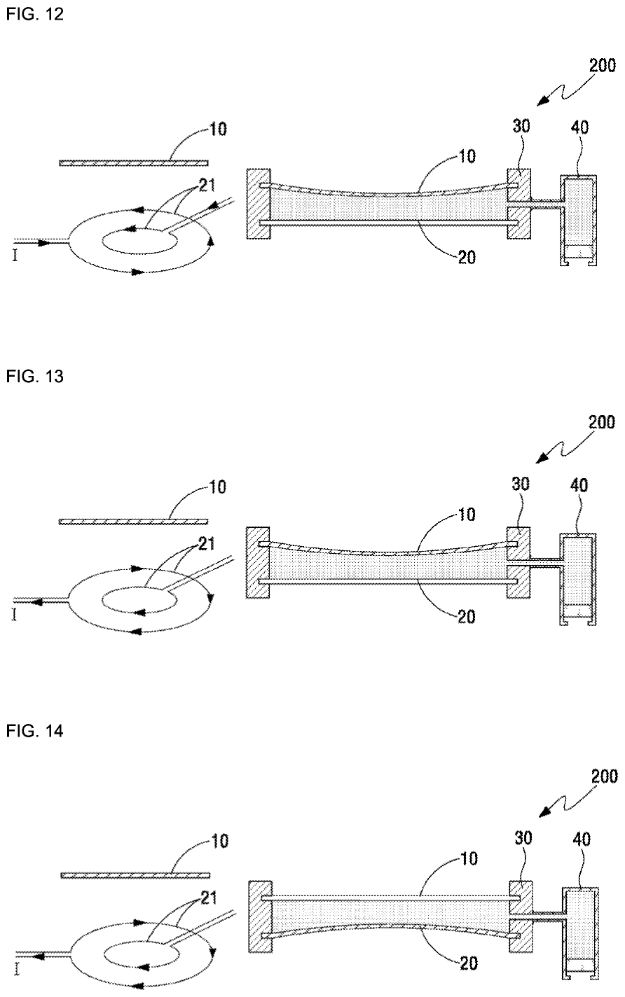

FIGS. 12 and 13 illustrate a fluidic lens 200 according to a second embodiment of the disclosure.

The fluidic lens 200 according to the second embodiment of the disclosure includes the first membrane 10, the second membrane 20, the fluid chamber 30, and the supplementary chamber 40 like the fluidic lens 100 according to the first embodiment.

However, unlike the fluidic lens 100 according to the first embodiment, the fluidic lens 200 according to the second embodiment of the disclosure includes the second means for exhibiting attraction or repulsion based on the surrounding magnetic field in the first membrane 10, and the first means for forming a variable magnetic field in the second membrane 20. In other words, the first means and the second means in the fluidic lens according to the disclosure may be included in any of the first membrane and the second membrane.

Further, unlike the first embodiment, the fluidic lens 200 according to the second embodiment of the disclosure may employ a ferromagnetic substance instead of the conducting wire as the second means.

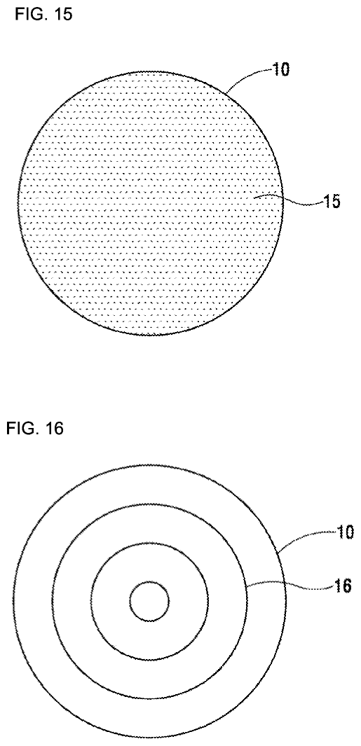

In more detail, the second means for exhibiting the attraction or repulsion based on the surrounding magnetic field may be achieved by granules (small granules or nanogranules) 15 of the ferromagnetic substance as dispersed and distributed in the first membrane as shown in FIG. 15. In this case, the granules of the ferromagnetic substance may be uniformly distributed as shown in FIG. 15, of may be nonuniformly distributed based on simulation results for distribution of a necessary magnetic force.

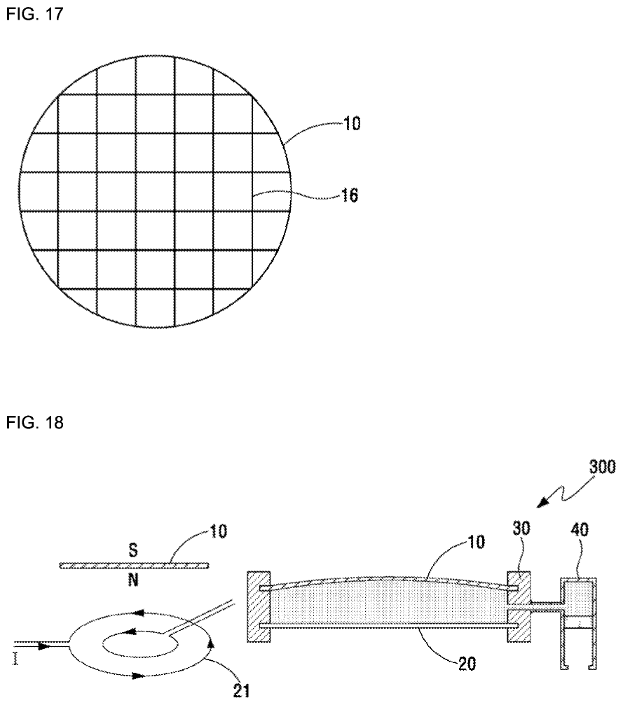

Further, the second means for exhibiting the attraction or repulsion based on the surrounding magnetic field may be formed with the ferromagnetic substance in various geographical patterns such as a concentric pattern of circles different in diameter, a lattice pattern, etc. as shown in FIGS. 16 and 17.

In this case, the band of the ferromagnetic substance formed into the ferromagnetic substance pattern is narrow in width, thereby increasing transmittance of rays passing through the lens when the lens is formed.

Further, the band of the ferromagnetic substance formed into the ferromagnetic substance pattern may be transparent in a visible region, thereby increasing transmittance of rays passing through the lens when the lens is formed.

Further, a thin film (not shown) of the ferromagnetic substance may be formed in the membrane as the second means for exhibiting the attraction or repulsion based on the surrounding magnetic field.

Further, the second means based on combination of two or more among the conducting wires, the small granules or nanogranules of the ferromagnetic substance, various geometrical patterns of the ferromagnetic substance, and the thin film of the ferromagnetic substance may be formed in the membrane.

The ferromagnetic substance forming the second means may contain iron, nickel, cobalt, ferrite, etc.

Further, the thin film of the ferromagnetic substance may contain an Fe—Cr—Zr or FeCo—(Al-fluoride)-based material.

Below, the fluidic lens 200 according to the second embodiment of the disclosure will be described in more detail with reference to FIGS. 12 and 13.

The fluidic lens according to the second embodiment of the disclosure, shown in FIGS. 12 and 13 includes an elastic membrane having flexibility as the first membrane 10, and a nonelastic membrane having no flexibility as the second membrane 20.

Further, the first membrane 10 contains the ferromagnetic substance as the second means for exhibiting the attraction or repulsion based on the surrounding magnetic field, and the second membrane 20 contains the conducting wire as the first means for generating the magnetic field.

When an electric current flows counterclockwise as shown in FIG. 12 in the conducting wire 21 of the second membrane of the fluidic lens 200 according to the second embodiment of the disclosure, the first membrane containing the ferromagnetic substance is pulled by the magnetic field formed in the second membrane, thereby forming a concave-plano lens having a negative refractive power.

Further, when an electric current flows clockwise as shown in FIG. 14 in the conducting wire of the second membrane of the fluidic lens 200 according to the second embodiment of the disclosure, the first membrane containing the ferromagnetic substance is also pulled by the magnetic field formed in the second membrane, thereby forming a concave-plano lens having a negative refractive power.

Although the distribution of the ferromagnetic substance of the first membrane 10 is changed based on one among or combination of two or more among the small granules or nanogranules of the ferromagnetic substance, various geometrical patterns of the ferromagnetic substance, and the thin film of the ferromagnetic substance, it is obvious that the operation principle of the second embodiment is unchangeable.

Further, as shown in FIG. 14, the fluidic lens 200 according to the second embodiment of the disclosure may include a nonelastic membrane having no flexibility as the first membrane 10, and an elastic membrane having flexibility as the second membrane 20.

In the fluidic lens 200, the magnetic field generated when an electric current flows in the conducting wire of the second membrane 20 pulls the ferromagnetic substance of the first membrane 10. In this case, the second membrane 20 is relatively pulled because the first membrane 10 is made of the nonelastic material having no flexibility, thereby forming a plano-concave lens having a negative refractive power.

In a case where both the first membrane 10 and the second membrane 20 according to the second embodiment of the disclosure are the elastic membranes having flexibility, the first membrane 10 and the second membrane 20 are all pulled by a magnetic force exhibited by the amount of electric current flowing in the second membrane 20, thereby forming a bi-concave lens, both sides of which are concave, having a negative refractive power.

In this second embodiment, when the ferromagnetic substance of the first membrane 10 is urged by the magnetic force within the magnetic field caused by the second membrane 20, the ferromagnetic substance may be a little magnetized even though the external magnetic field disappears. To initialize the fluidic lens, there is a need of demagnetizing the ferromagnetic substance. In this case, the direction of the electric current flowing in the second membrane 20 is reversed, and the amount of electric current is allowed to flow based on a level calculated by simulation (in general, lower than the electric current first applied to make the fluidic lens), thereby removing magnetic properties from and initializing the magnetized ferromagnetic substance.

The fluidic lens 200 according to the second embodiment of the disclosure becomes a concave lens always having the negative refractive power, but it is possible to change the focal length by changing the strength of electric current applied to the conducting wire used as the first means for generating a variable magnetic field of the second membrane.

As described hitherto, the fluidic lens according to the second embodiment of the disclosure becomes the concave lens always having the negative refractive power. However, when the ferromagnetic substance is magnetized within a uniform magnetic field and then included in one membrane of the fluidic lens, this membrane forms the magnetic field. Then, such a magnetized ferromagnetic substance can serve as the second means for exhibiting the attraction or repulsion based on the surrounding magnetic field. Therefore, when the first means for generating a variable magnetic field is provided in the other membrane of the fluidic lens, the attraction and the repulsion can occur between the two membranes, thereby transforming the fluidic lens into not only the concave lens but also the convex lens.

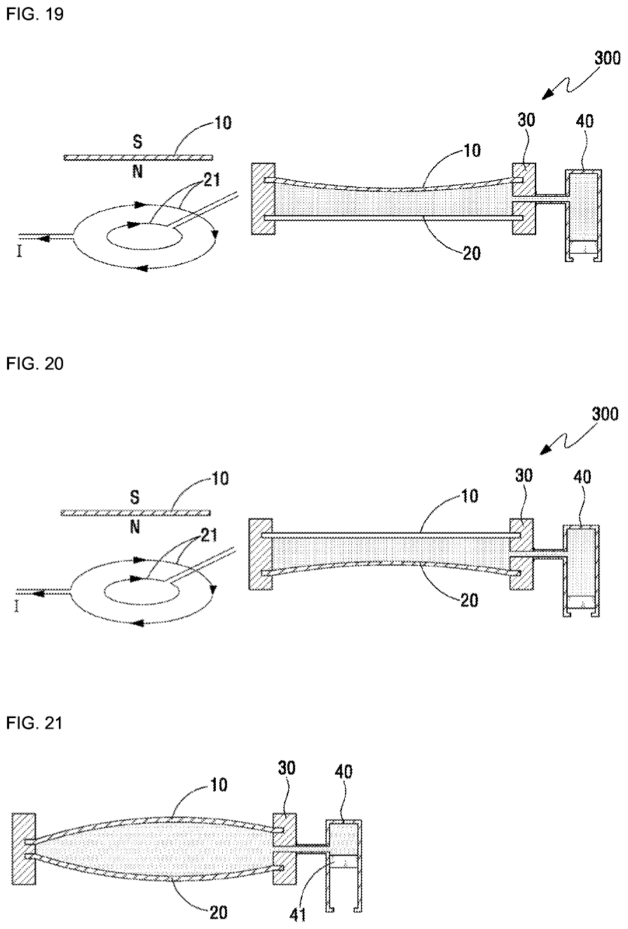

Below, a fluidic lens 300 according to a third embodiment of the disclosure will be described in more detail with reference to FIGS. 18 and 19.

The fluidic lens 300 according to the third embodiment of the disclosure, shown in FIGS. 18 and 19 includes an elastic membrane having flexibility as the first membrane 10, and a nonelastic membrane having no flexibility as the second membrane 20.

Further, in the fluidic lens 300 shown in FIGS. 18 and 19, the first membrane 10 contains a magnetized ferromagnetic substance as the second means for exhibiting the attraction or repulsion based on the surrounding magnetic field. In this case, for example, the ferromagnetic substance may be being magnetized so that the center of the top side of the first membrane 10 can serve as the S pole and the center of the bottom side can serve as the N pole, and the second membrane 20 may contain the conducting wire 21 as the first means for forming a variable magnetic field.

When an electric current flows counterclockwise as shown in FIG. 18 in the conducting wire 21 of the second membrane 20 of the fluidic lens 300 according to the third embodiment of the disclosure, the center of the top side of the second membrane serves as the N pole, and thus repulsion occurs between the first membrane and the second membrane, thereby making the fluidic lens 300 as a convex-plano lens having positive refractive power.

Further, when an electric current flows clockwise as shown in FIG. 19 in the conducting wire of the second membrane of the fluidic lens 300 according to the third embodiment of the disclosure, the center of the top side of the second membrane serves as the S pole, and thus attraction occurs between the first membrane and the second membrane, thereby making the fluidic lens 300 as a concave-plano lens having negative refractive power.

Further, as shown in FIG. 20, the fluidic lens 300 according to the third embodiment of the disclosure may include the first membrane 10 made of a nonelastic material having no flexibility, and the second membrane 20 made of an elastic material having flexibility.

In the fluidic lens 300 as shown in FIG. 20, the center of the top side of the second membrane serves as the S pole and pulls the ferromagnetic substance of the first membrane when an electric current flows clockwise in the conducting wire of the second membrane 20. In this case, the second membrane 20 is relatively pulled because the first membrane 10 is made of the nonelastic material having no flexibility, thereby forming a plano-concave lens having a negative refractive power.

It will be understood that a plano-convex lens is formed having a positive refractive power when an electric current flows counterclockwise in the conducting wire 21 of the fluidic lens as shown in FIG. 20.

Further, a bi-concave lens or bi-convex lens may be formed when both the first membrane 10 and the second membrane 20 according to the third embodiment of the disclosure are the elastic membranes.

The fluidic lens 300 according to the third embodiment of the disclosure may be transformed into a concave lens or a convex lens according to directions of electric current applied to the conducting wire used as the first means for forming the magnetic field. Further, the fluidic lens 300 according to the third embodiment of the disclosure may be varied in focal length depending on the strength of the electric current.

Further, the magnetized ferromagnetic substance may be based on one among or combination of two or more among granules, various geometrical patterns of the ferromagnetic substance, and the thin film of the ferromagnetic substance.

Further, in the embodiments described hitherto, it is obvious that the fluid of the fluidic lens needs to be a material having optical transmittance in a specific spectrum region so that a fluidic lens with a variable focal length can be effective in the specific spectrum region.

Although it has been described in the foregoing embodiments that the non-elastic membrane having no flexibility has a flat surface, it will be appreciated that the non-elastic membrane having no flexibility may have a curved surface such as a spherical surface, an aspherical surface, etc.

Further, it has been described in the foregoing embodiments that one or more first means for generating a magnetic field is provided in one of the first membrane and the second membrane and one or more second means for exhibiting a magnetic force based on the surrounding magnetic field is provided in the other one. However, the first means and the second means may be mixed in one of the first membrane and the second membrane.

In other words, each of the first means and the second means may work to cause the attraction or the repulsion even when the first means and the second means are provided as mixed in the first membrane, and the first means or the second means or the first means and the second means are provided as mixed in the second membrane, thereby leading to change in the volume of the space between the first membrane and the second membrane, and achieving a fluidic lens with a variable focal length.

Further, it has been illustrated in the drawings of the foregoing embodiments that the fluid chamber makes the distance between the edge of the first membrane and the edge of the second membrane be constant in any region. However, as shown in FIG. 21, a distance between the edge of the first membrane and the edge of the second membrane in a certain region may be different from a distance in another region.

Although detailed embodiments of a fluidic lens with a variable focal length according to the disclosure have been described, the disclosure is not limited to such detailed embodiments, and various changes and modifications can be made without departing from the spirit and scope of the invention defined in the appended claims

[Reference Numerals]

| | |
|---|---|
| 10: first membrane | 20: second membrane |
| 11, 21: conducting wire | 12, 13, 22, 23 electric wires |
| 30: fluid chamber | 40: supplementary chamber |
| 41: movable piece | 42: tension spring |
| 43: compression spring | |

1. A fluidic lens comprising:
a first membrane comprising one or more first means for forming a variable magnetic field;
a second membrane comprising one or more second means for exhibiting a magnetic force based on a surrounding magnetic field;
a fluid chamber forming a space between the first membrane and the second membrane while holding an edge of the first membrane and an edge of the second membrane at positions opposite to each other, and comprising fluid filled in the space; and
a supplementary chamber connected to the fluid chamber, supplying the fluid to the space when the space is increased in volume and receiving the fluid from the space when the space is decreased in volume.

2. The fluidic lens according to claim 1, wherein the first membrane further comprises the second means, or the second membrane further comprises the first means, or the first membrane further comprises the second means and the second membrane further comprises the first means.

3. The fluidic lens according to claim 1, wherein the first means or the second means comprises a conducting wire.

4. The fluidic lens according to claim 1, wherein the second means comprises a ferromagnetic substance or a magnetized ferromagnetic substance.

5. The fluidic lens according to claim 4, wherein the ferromagnetic substance comprises one or more among dispersed ferromagnetic-substance granules, a geometrical ferromagnetic-substance pattern, and a thin ferromagnetic-substance film.

6. The fluidic lens according to claim 1, wherein the first means and the second means comprise a material having optical transmittance in a visible region.

7. The fluidic lens according to claim 1, wherein the supplementary chamber comprises a pressure means for providing pressure to the fluid.

8. The fluidic lens according to claim 7, wherein the supplementary chamber comprises a movable piece forming a boundary between a space filled with fluid and the rest of the space, and the pressure means comprises a tension spring comprising one end connected to the movable piece and positioned inside the space filled with the fluid, or a compression spring comprising one end connected to the movable piece and positioned inside the rest of the space.

9. The fluidic lens according to claim 3, wherein the conducting wire comprises a circular conducting-wire opened at one side or a spiral conducting-wire.

10. The fluidic lens according to claim 9, wherein the conducting wire comprises a first end and a second end to which two parallel electric wires are connected, respectively.

11. The fluidic lens according to claim 3, wherein the conducting wire comprises a plurality of circular conducting-wires opened at one side, and the plurality of circular conducting-wires are concentrically arranged and different in diameter from each other.

12. The fluidic lens according to claim 11, wherein each of the circular conducting-wires comprises a first end and a second end to which two parallel electric wires are connected, respectively.

13. The fluidic lens according to claim 1, wherein the first membrane and/or the second membrane comprises an elastic material having flexibility.
